(19) United States
(12) Patent Application Publication
(10) Pub. No.: US 2018/0194464 A1
(43) Pub. Date: Jul. 12, 2018

(54) Drone Washing

(71) Applicant: Jesse E. Elder, Mount Vernon, WA (US)

(72) Inventor: Jesse E. Elder, Mount Vernon, WA (US)

(21) Appl. No.: 15/852,466

(22) Filed: Dec. 22, 2017

Related U.S. Application Data
(60) Provisional application No. 62/444,189, filed on Jan. 9, 2017.

(51) Int. Cl. B64C 39/02; B08B 3/02

(52) U.S. Cl. CPC B64C 39/024; B64D 47/08; B08B 3/024

(57) ABSTRACT

Disclosed is a method and apparatus for performing high volume washing, namely, using drones to perform cleaning services. A drone is navigated about a cleaning path; the cleaning path being either pre-defined or delineated in real-time. A cleaning solution is pumped to a solution distribution mechanism of the drone, wherein the cleaning solution is directed onto the surface to be cleaned. The solution is stored in a supply tank that may be integrated into the body of the drone or outfitted as a standalone structure. A temperature regulator is integrated with the supply tank in order to control a wash temperature of the cleaning solution. The solution distribution mechanism may be rotatable about 360 degrees. A camera array observes a spray area of the solution distribution mechanism, wherein a live feed is transmitted to a monitoring unit.

The current application claims a priority to the U.S. Provisional Patent application Ser. No. 62/444,189 filed on Jan. 9, 2017.

### FIELD OF THE INVENTION

The present invention relates generally to a method and apparatus for cleaning.

More specifically, the present invention provides a method for cleaning structures using drones.

### BACKGROUND OF THE INVENTION

Cleaning is a task that not many people care to do. It requires physical effort and can be quite exhausting, especially if there is a large area to be cleaned. Furthermore, cleaning can also be a dangerous task if the object to be cleaned requires an individual to deal with heights, such as cleaning roofs and gutters or performing window washing services for large buildings. Ideally, such cleaning tasks could be carried out autonomously by pre-programmed drones or carried out by remotely piloted drones. Such a system would alleviate the risks associated with high elevation cleaning and would eliminate the physical stress of cleaning.

Therefore, it is an objective of the present invention to provide a method and apparatus for performing cleaning services, namely, using drones to perform cleaning services. A drone is navigated about a cleaning path; the cleaning path being either pre-defined or delineated in real-time. A cleaning solution is pumped to a solution distribution mechanism of the drone, wherein the cleaning solution is directed onto the surface to be cleaned. The solution is stored in a supply tank that may be integrated into the body of the drone or outfitted as a standalone structure. A temperature regulator is integrated with the supply tank in order to control a wash temperature of the cleaning solution. The solution distribution mechanism may be rotatable about 360 degrees. A camera array observes a spray area of the solution distribution mechanism, wherein a live feed is transmitted to a monitoring unit.

### BRIEF DESCRIPTION OF THE DRAWINGS

FIG. 1 is a perspective view of a drone washing system, wherein the supply tank is integrated into the body of the drone.

FIG. 2 is a perspective view of a drone washing system, wherein the supply tank is a portable fixture, separate from the drone.

FIG. 3 is a diagram showing the electrical connections of the processor, and the communication capabilities of the transmitter and the receiver.

FIG. 4 is a diagram depicting a drone being used to wash a residential roof.

FIG. 5 is a diagram depicting a drone being used to wash a skyscraper.

FIG. 6 is a diagram depicting a drone being used to wash an airplane, wherein the camera feed is displayed on a monitoring unit.

FIG. 7 is a flowchart depicting the steps for performing high volume washing using drones.

FIG. 8 is a flowchart thereof, further depicting the step of regulating the temperature of the cleaning solution.

FIG. 9 is a flowchart thereof, further depicting the step of regulating the exit flow rate of the cleaning solution from the solution distribution mechanism.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the below-disclosed aspects of the disclosure and may further incorporate only one or a plurality of the below-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present invention provides a method and apparatus for performing cleaning services using drones. The present invention can be used for high volume washing, pressure washing, power washing, commercial cleaning, industrial cleaning, residential cleaning, structural cleaning, etc. The present invention can be used in cleaning aircraft, automotive vehicles, trucks, trailers, buildings, roofs, chimneys, windows, gutters, or any other desired surface or structure. The present invention can be implemented as a portable system,

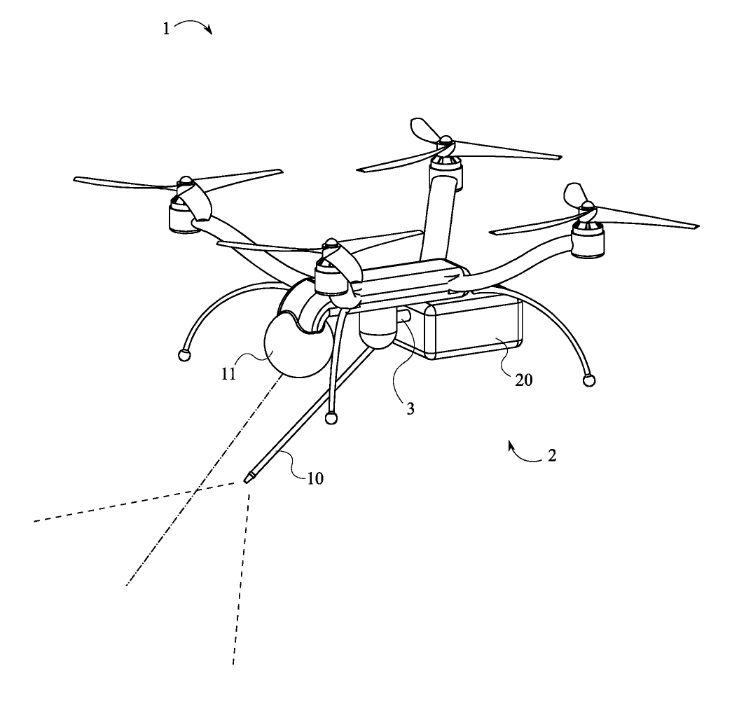

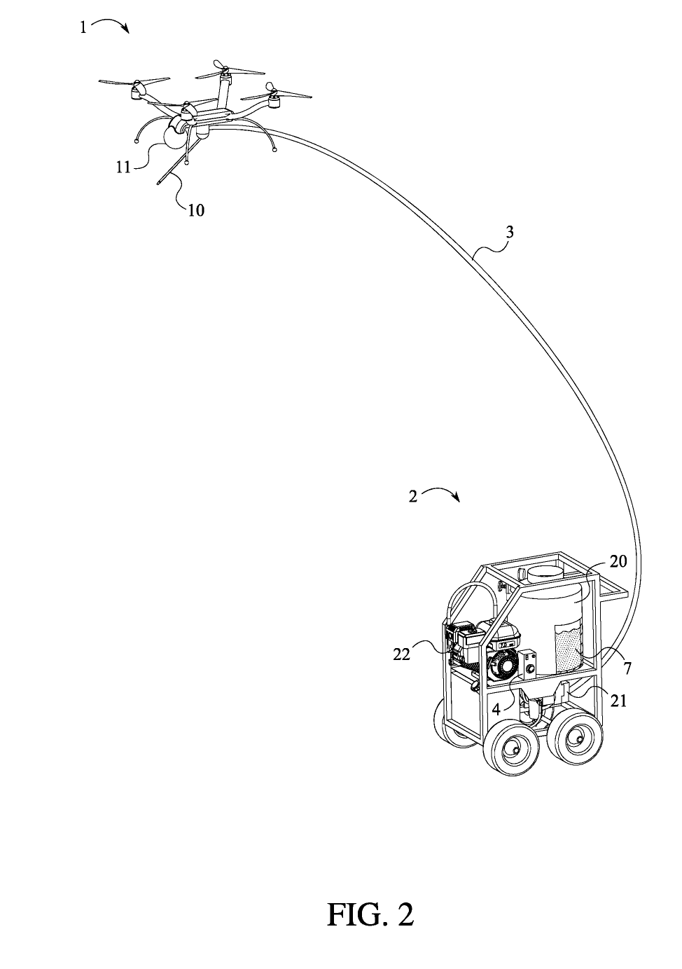

In reference to FIG. 1-2, in some embodiments, a drone 1, a supply tank 2, and a solution feed tube 3 are provided for performing the washing. The drone 1 may comprise a solution distribution mechanism 10, a camera array 11, a processor 12, and a transmitter 14, while the supply tank 2 may comprise a reservoir 20, a pump 21, and a driver 22. The supply tank 2 is utilized to store a cleaning solution 7 that is delivered to the drone 1 via the solution feed tube 3 for disbursement through the solution distribution mechanism 10.

In reference to FIG. 2, the pump 21 is integrated with the reservoir 20, such that the cleaning solution 7 can be extracted from the reservoir 20. In one embodiment, the pump 21 may be positioned within the reservoir 20, wherein the pump 21 is submerged in the cleaning solution 7. In another embodiment, the pump 21 may be externally positioned about the reservoir 20, wherein the pump 21 is mounted about an opening in the reservoir 20, allowing the pump 21 to pull the cleaning solution 7 through the opening.

The pump 21 includes a series of blades that are rotated in order to propel the cleaning solution 7 from the reservoir 20 and through the solution feed tube 3. The driver 22 is operably coupled to the pump 21, wherein the driver 22 rotates a shaft about which each of the blades is connected. In some embodiments, the driver 22 is an electric motor. In other embodiments, the driver 22 is a gas-powered engine. The specifications of the driver 22 are dependent on the proximity of the reservoir 20 to the drone 1, the required cleaning pressure, and the specifications of the drone 1.

In reference to FIG. 1-2, the solution feed tube 3 is terminally connected at one end to the solution distribution mechanism 10, and terminally connected to the pump 21 at the opposite end. In this way, the solution distribution mechanism 10 is in fluid communication with the pump 21 through the solution feed tube 3 and the pump 21. The inner diameter, outer diameter, and length of the solution feed tube 3 may vary throughout different embodiments of the present invention; the length of the solution feed tube 3 varying in particular, according to the position of the reservoir 20 in relation to the drone 1.

In reference to FIG. 2, in one embodiment, the drone 1 is an unmanned aerial vehicle (UAV) and the supply tank 2 is a grounded fixture, wherein the drone 1 is tethered to the supply tank 2 by the solution feed tube 3. The solution feed tube 3 is made from a flexible material, such that the solution feed tube 3 does not hinder the flight of the drone 1. The cleaning solution 7 is extracted from the reservoir 20 and propelled up the solution feed tube 3 to the solution distribution mechanism 10 via the pump 21. The drone 1 is navigated around the structure that is to be cleaned either by following a pre-programmed path or by being controlled remotely in real-time.

In reference to FIG. 1, in another embodiment, the drone 1 is a UAV and the supply tank 2 is integrated with the drone 1. The solution feed tube 3 may be constructed from a flexible or rigid material, as the supply tank 2 is fixed in one place and carried by the drone 1. While the supply tank 2 is limited in size and holding capacity compared to that of a grounded tank, the pump 21 can be much less powerful, as the supply tank 2 is in much closer proximity to the solution distribution mechanism 10; thus, the solution feed tube 3 is shorter and the cleaning solution 7 does not need to be pumped as far. The drone 1 is navigated around the structure that is to be cleaned either by following a pre-programmed path or by being controlled remotely in real-time.

In other embodiments, the drone 1 may be an unmanned spacecraft, an unmanned ground vehicle (UGV), unmanned surface vehicle (USV), autonomous underwater vehicle (AUV), or any other remotely controlled or pre-programmed vehicle, such as a cable guided drone or a pole suspended drone. In some embodiments, the drone 1 may be electrically powered, such as using solar power or battery power. In other embodiments, the drone 1 may be fossil fuel powered, such as using gas to power the drone 1. In yet other embodiments, the drone 1 may be biofuel powered.

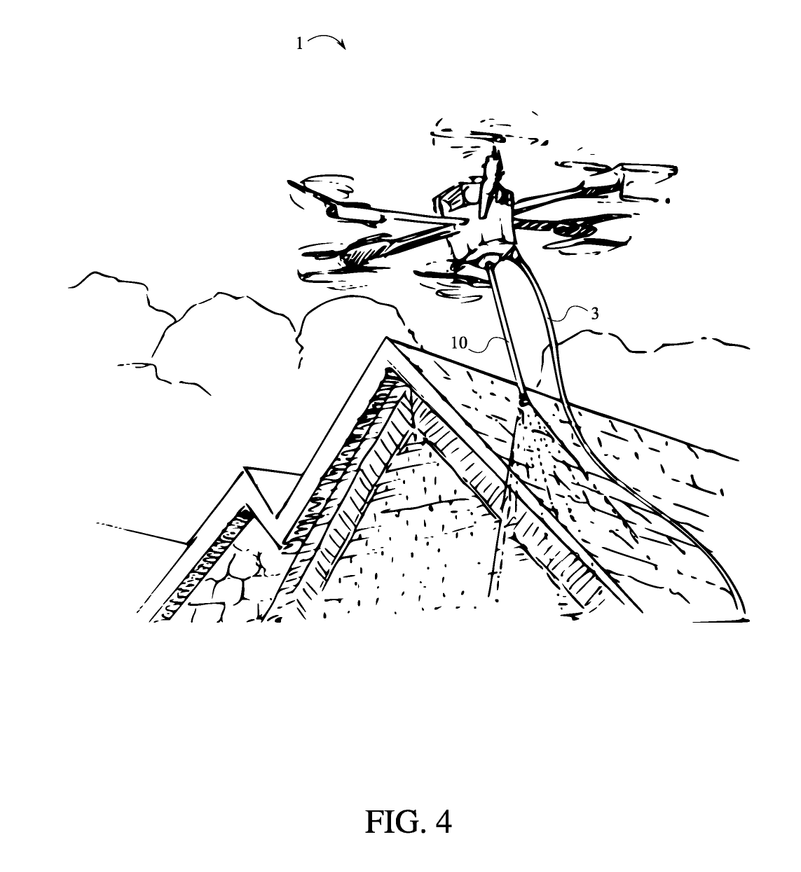

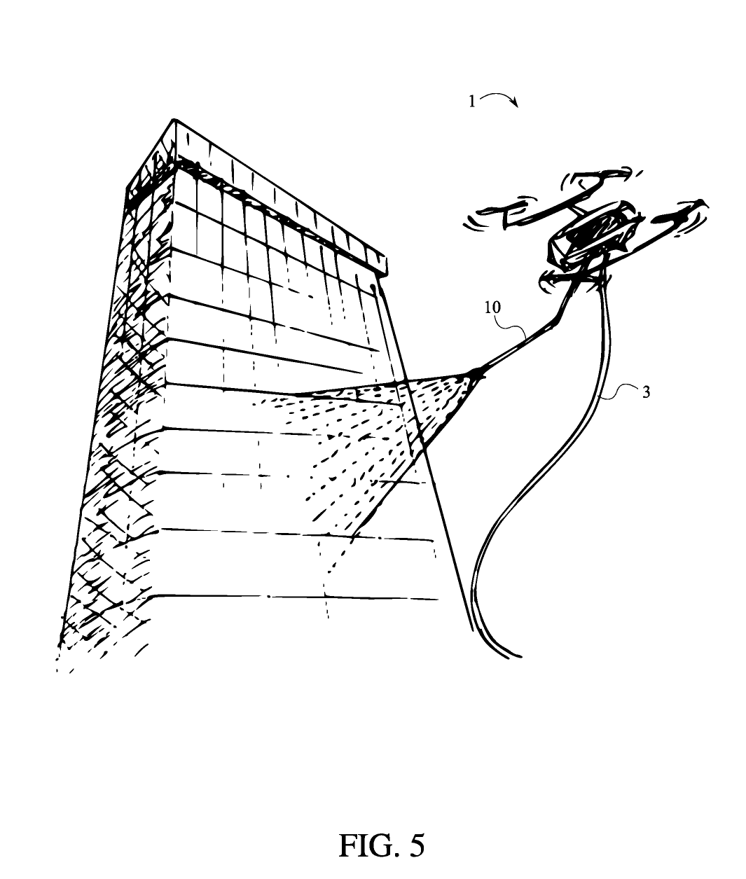

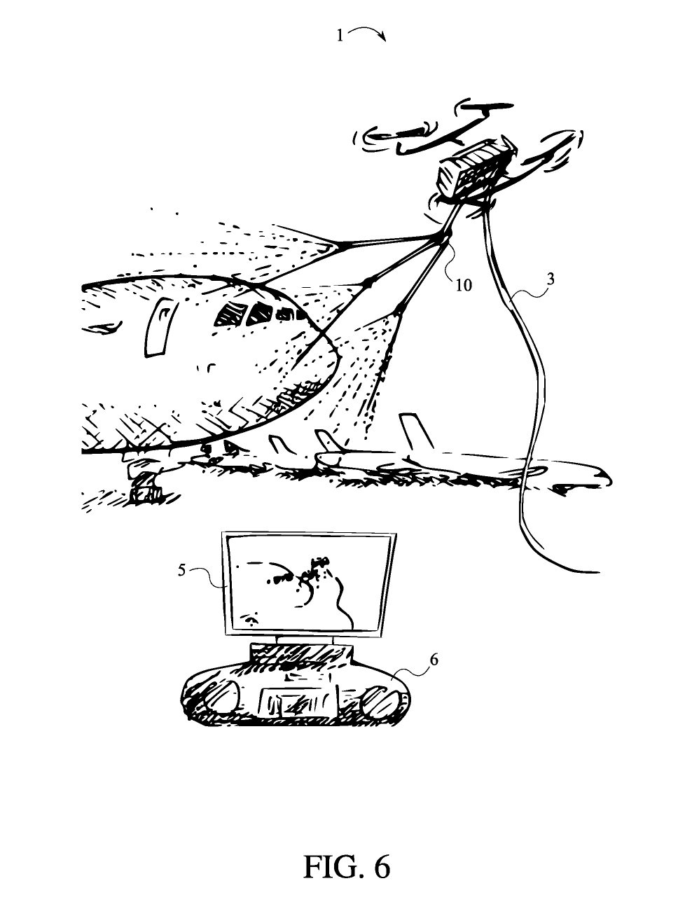

The solution distribution mechanism 10 is used to direct and expel the cleaning solution 7 onto the structure to be cleaned. The solution distribution mechanism 10 has one or more spray nozzles, as shown in FIG. 4-6, that dictate the spray pattern, spray impact, spray angle and coverage, and the spray drop size of the cleaning solution 7, as the cleaning solution 7 is expelled from the solution distribution mechanism 10. Through the one or more spray nozzles, the solution distribution mechanism 10 regulates the exit flow rate of the cleaning solution 7, allowing for both high-pressure and low-pressure cleaning. In one embodiment, each of the one or more nozzles is a high-end unloader that aids in the relief of pressure as the cleaning solution 7 is disbursed from the solution distribution mechanism 10. In some embodiments, the solution distribution mechanism 10 may be configured to disperse a steam for steam cleaning applications.

Furthermore, the solution distribution mechanism 10 can be maneuvered relative to the body of the drone 1, wherein the solution distribution mechanism 10 can be re-angled while the drone 1 remains stationary. In some embodiments, the solution distribution mechanism 10 is rotatable about 360 degrees, allowing the cleaning solution 7 to be distributed in a radius surrounding the drone 1. The movement of the solution distribution mechanism 10 may be pre-determined, or manually controlled such that a particularly dirty area can be focused on.

The present invention may further comprise a temperature regulator 4 for adjusting the temperature of the cleaning solution 7. In one embodiment, the temperature regulator 4 is integrated with the reservoir 20, as shown in FIG. 2, such that the temperature regulator 4 controls the temperature of the entirety of the cleaning solution 7 at one time. In another embodiment, the temperature regulator 4 is integrated with the solution distribution mechanism 10, wherein the temperature of the cleaning solution 7 is not controlled until the cleaning solution 7 is pumped to the drone 1. In yet another embodiment, the temperature regulator 4 is integrated with the solution feed tube 3, wherein the temperature of the cleaning solution 7 is regulated throughout the process of pumping the cleaning solution 7 to the drone 1.

In some embodiments, the reservoir 20 may be separated into more than one compartment, wherein different cleaning solutions are stored in each of the compartments. Each of the cleaning solutions may be passed through the same pump 21 and the same solution feed tube 3, or through separate pumps and feed tubes. Similarly, the temperature of each cleaning solution 7 may be controlled by the same temperature regulator 4, or by separate temperature regulators.

The cleaning solution 7 may be a compound, solution, mixture, or any other substance used in cleaning. In some embodiments, the cleaning solution 7 is water, either hot or cold. In other embodiments, the cleaning solution 7 includes chemicals to assist in the washing. In yet other embodiments, the cleaning solution 7 is air. In other embodiments, the cleaning solution 7 is an air and water mixture. The cleaning solution 7 may also be a deicing solution or mixture, a fire extinguishing solution or mixture, or a fire retardant application.

In reference to FIG. 1, the camera array 11 is oriented to observe a spray area of the solution distribution mechanism 10, wherein the camera array 11 comprises one or more cameras. The spray area is defined by the nozzle characteristics of the solution distribution mechanism 10 and may be in a single direction, or multiple directions depending on the configuration of the solution distribution mechanism 10. In embodiments where the solution distribution mechanism 10 includes more than one spray nozzle, each spray nozzle may be paired with a camera from the camera array 11. In this way, the cleaning performed by each of the spray nozzles can be observed individually.

The cameras of the camera array 11 may be simply used to relay video feeds to the user, or the cameras may be used for camera assisted, or camera guided, navigation of the drone 1. Preferably each of the cameras of the camera array 11 is a high resolution, or high definition, camera. In some embodiments, each of the cameras of the camera array 11 is a water resistant camera. In some embodiments, each of the cameras of the camera array 11 is a water proof camera. In some embodiments, each of the cameras of the camera array 11 has night vision capabilities.

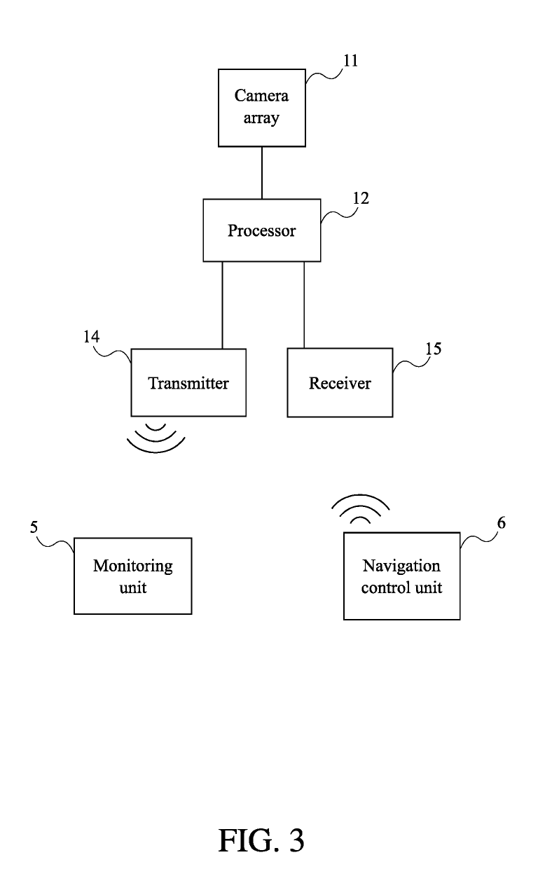

In reference to FIG. 3, the camera array 11 is electrically connected to the processor 12, wherein the processor 12 receives one or more data streams from the camera array 11. Each of the data streams contains information regarding the visual aspects of the spray area observed by the camera array 11. The processor 12 may perform functions on the data streams including, but not limited to, compressing the data streams and encrypting the data streams. The transmitter 14 is electrically connected to the processor 12, wherein either the raw or manipulated data streams are passed from the camera array 11 and through the processor 12 to the transmitter 14.

In further reference to FIG. 3, the transmitter 14 is communicably coupled with a monitoring unit 5, wherein the monitoring unit 5 displays a camera feed from the camera array 11 on a display screen. The transmitter 14 wirelessly relays the raw or manipulated data streams from the processor 12 to the monitoring unit 5, wherein the monitoring unit 5 converts the data streams into the camera feed. In some embodiments, the camera feed is displayed in real-time, along with the washing of the structure, such that an individual can observe and assess the cleaning process in real-time and make any necessary alterations to the flight path, washing pressure, etc. In other embodiments, the monitoring unit 5 stores the data streams on a storage medium, such that the camera feed can be observed at a later time.

In reference to FIG. 3, in some embodiments, the drone 1 further comprises a receiver 15 that is utilized to receive signals from a navigation control unit 6. The navigation control unit 6 is utilized to manually control the trajectory of the drone 1, adjust the aim or pressure of the solution distribution mechanism 10, adjust the observable area of the camera array 11, and control any other functions of the drone 1 throughout the cleaning process. The receiver 15 is electronically connected to the processor 12 and communicably coupled to the navigation control unit 6, such that the receiver 15 relays signals from the navigation control unit 6 to the processor 12. The processor 12 then interprets the signals and performs the designated functions and operations.

In embodiments where both the transmitter 14 and the receiver 15 are utilized, the transmitter 14 and the receiver 15 may be combined into a single unit, namely, a transceiver. This reduces the weight of the drone 1 and reduces the number of interfacing components. Similarly, in embodiments where both the monitoring unit 5 and the navigation control unit 6 are utilized, the monitoring unit 5 and the navigation control unit 6 may be combined into a single unit, namely, a monitoring and control unit. The use of the monitoring and control unit is of particular benefit when manually navigating the drone 1.

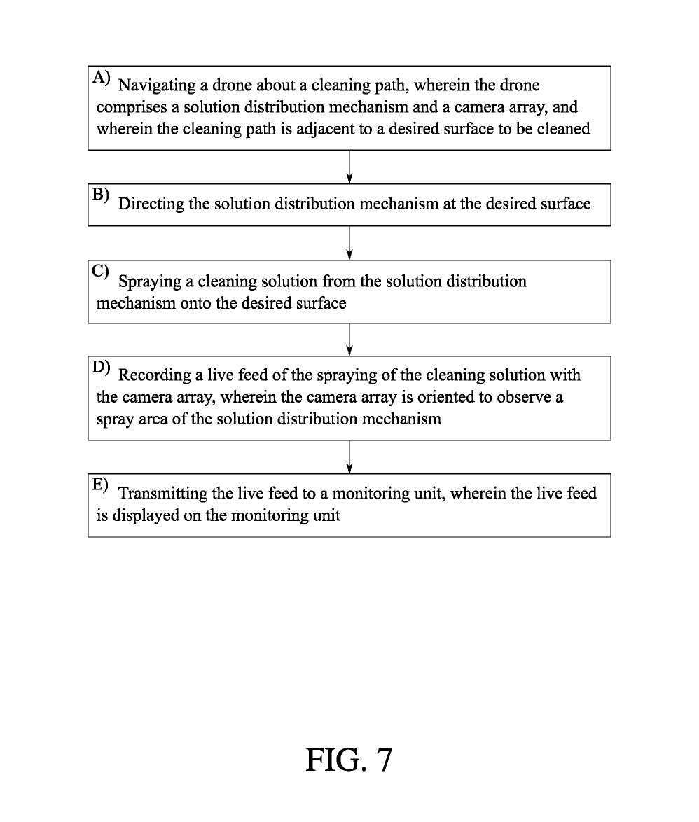

In reference to FIG. 7, in one embodiment of the present invention, the method for performing cleaning services using drones comprises the steps of: navigating the drone 1 about a cleaning path, wherein the cleaning path is adjacent to a desired surface to be cleaned; directing the solution distribution mechanism 10 at the desired surface; spraying the cleaning solution 7 from the solution distribution mechanism 10 onto the desired surface; recording a live feed of the spraying of the cleaning solution 7 with the camera array 11; and transmitting the live feed to the monitoring unit 5, wherein the live feed is displayed on the monitoring unit 5.

The cleaning path can be pre-defined or delineated in real-time by receiving instructions from the navigation control unit 6. In some embodiments, the camera array 11 is used to assist in the navigation of the drone 1. In other embodiments, a global positioning system (GPS) device is utilized in the navigation of the drone 1. In yet other embodiments, the drone 1 is navigated using laser guidance.

In embodiments where the cleaning path is pre-defined, navigation information defining the cleaning path is uploaded to the drone 1 prior to performing the cleaning. The navigation information can be uploaded wirelessly via the receiver 15, or through a wired connection between the processor 12 and a computing device. The navigation information is then stored on a storage medium of the drone 1, wherein the processor 12 executes commands to navigate the drone 1 about the cleaning path. In some embodiments, the drone 1 may be programmed to navigate using a GPS device, or other similar position location device.

In embodiments where the cleaning path is delineated in real-time, a continuous data stream is kept between the drone 1 and the navigation control unit 6. Navigation commands are input through the navigation control unit 6 and relayed to the processor 12 via the receiver 15. Meanwhile, navigational responses and other feedback are sent from the processor 12 to the navigation control unit 6 via the transmitter 14. The navigation commands may be voice activated inputs, physical inputs through physical controls, motion gesture inputs, or any other suitable means of inputting commands to an electronic interface.

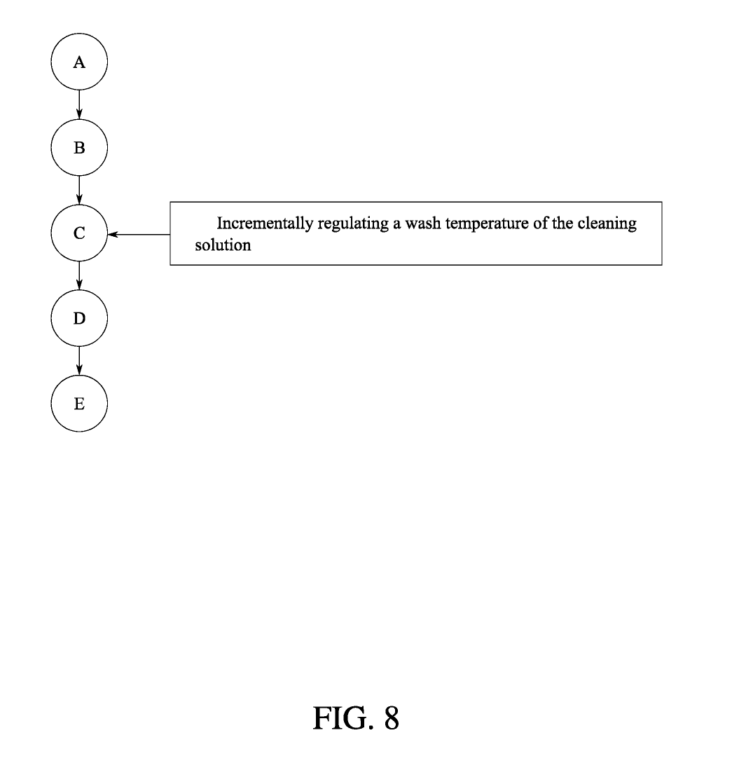

In reference to FIG. 8, the method for performing high volume washing may further comprise the step of incrementally regulating a wash temperature of the cleaning solution 7. The wash temperature of the cleaning solution 7 is incrementally increased or decreased by the temperature regulator 4. In some embodiments, the temperature regulator 4 may be pre-programmed to adjust the wash temperature at select points in the cleaning process. In other embodiments, the temperature regulator 4 may be manually controlled through user inputs to the navigation control unit 6 or user inputs directly into the temperature regulator 4.

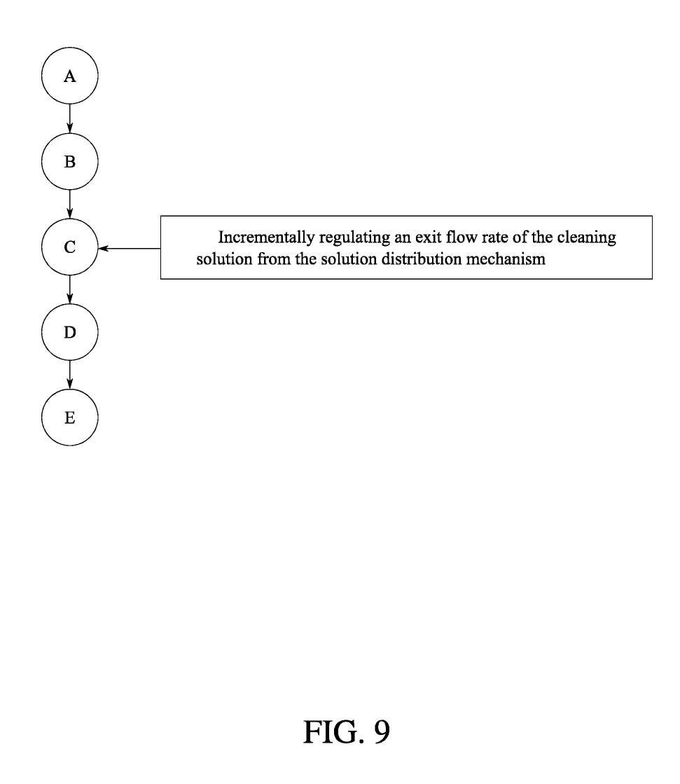

In reference to FIG. 9, the method for performing high volume washing may further comprise the step of incrementally regulating the exit flow rate of the cleaning solution 7 from the solution distribution mechanism 10. The exit flow rate is incrementally increased or decreased by adjusting the spray pattern or the spray angle of the one or more nozzles of the solution distribution mechanism 10, by adjusting the flow rate of the pump 21, or a combination thereof. In some embodiments, the solution distribution mechanism 10, or the pump 21, may be pre-programmed to adjust the exit flow rate at select points in the cleaning process. In other embodiments, the solution distribution mechanism 10, or the pump 21, may be manually controlled through user inputs to the navigation control unit 6.

Although the invention has been explained in relation to its preferred embodiment, it is to be understood that many other possible modifications and variations can be made without departing from the spirit and scope of the invention as hereinafter claimed.

What is claimed is:

1. A drone washing system comprises:
a drone;
a supply tank;
a solution feed tube;
the drone comprising a solution distribution mechanism, a camera array, a processor, and a transmitter;
the supply tank comprising a reservoir, a pump, and a driver;
the solution feed tube being terminally connected to the solution distribution mechanism;
the solution feed tube being terminally connected to the pump;
the pump being integrated with the reservoir;
the solution distribution mechanism being in fluid communication with the reservoir through the solution feed tube and the pump;
the camera array being oriented to observe a spray area of the solution distribution mechanism;
the driver being operably coupled to the pump; and
the processor being electronically connected in between the transmitter and the camera array.

2. The drone washing system as claimed in claim 1 comprises:
a temperature regulator; and
the temperature regulator being integrated with the reservoir.

3. The drone washing system as claimed in claim 1 comprises:
the transmitter being communicably coupled to a monitoring unit, wherein the monitoring unit displays a camera feed from the camera array.

4. The drone washing system as claimed in claim 1 comprises:
the drone further comprising a receiver;
the receiver being electronically connected to the processor; and
the receiver being communicably coupled to a navigation control unit.

5. The drone washing system as claimed in claim 1 comprises:
a cleaning solution; and
the cleaning solution being stored in the reservoir for disbursement through the solution distribution mechanism.

6. The drone washing system as claimed in claim 5, wherein the solution distribution mechanism regulates an exit flow rate of the cleaning solution.

7. The drone washing system as claimed in claim 1, wherein the solution distribution mechanism is rotatable about 360 degrees.

8. A method for performing cleaning services using drones comprises the steps of:
navigating a drone about a cleaning path, wherein the drone comprises a solution distribution mechanism and a camera array, and wherein the cleaning path is adjacent to a desired surface to be cleaned;
directing the solution distribution mechanism at the desired surface;
spraying a cleaning solution from the solution distribution mechanism onto the desired surface;
recording a live feed of the spraying of the cleaning solution with the camera array, wherein the camera array is oriented to observe a spray area of the solution distribution mechanism; and
transmitting the live feed to a monitoring unit, wherein the live feed is displayed on the monitoring unit.

9. The method for performing cleaning services using drones, the method as claimed in claim 8 further comprises the step of:
incrementally regulating a wash temperature of the cleaning solution.

10. The method for performing cleaning services using drones, the method as claimed in claim 8 further comprises the step of:
incrementally regulating an exit flow rate of the cleaning solution from the solution distribution mechanism.

11. The method for performing cleaning services using drones, the method as claimed in claim 8, wherein the cleaning path is predefined.

12. The method for performing cleaning services using drones, the method as claimed in claim 8, wherein the cleaning path is delineated in real-time by receiving instructions from a navigation control unit.

13. The method for performing cleaning services using drones, the method as claimed in claim 8, wherein the solution distribution mechanism is rotatable about 360 degrees.
